(19) United States
(12) Patent Application Publication
(10) Pub. No.: US 2015/0117006 A1
(43) Pub. Date: Apr. 30, 2015

(54) LED Matrix Display Screen

(71) Applicant: ANMINGLI STAGE LIGHTING MANUFACTURER CO., LTD, Guangzhou City (CN)

(72) Inventor: Ying CAI, Guangzhou City (CN)

(73) Assignee: ANMINGLI STAGE LIGHTING MANUFACTURER CO., LTD, Guangzhou City (CN)

(21) Appl. No.: 14/105,731

(22) Filed: Dec. 13, 2013

(30) Foreign Application Priority Data
Oct. 30, 2013 (CN) 201320677926.5

(51) Int. Cl. F21K 99/00; F21V 29/00

(52) U.S. Cl. CPC F21K 9/30; F21V 29/2206
USPC 362/249.02

(57) ABSTRACT

The embodiment of the utility patent discloses a LED matrix display screen, which comprises multiple horizontal circuit board and vertical circuit board. The multiple horizontal circuit board, equidistantly welded with LED beads, are equidistantly welded on the vertical circuit board. And the vertical circuit board is equipped with the controller which can control the LED lamps welded on the horizontal circuit board. The embodiment of the utility patent LED matrix display screen, through multiple arranged LED lamp, can better display different graphics. Moreover, each row of the LED lamps are equipped on the horizontal circuit board. Result from that it not only will be better to decrease the distance between every LED lamps and reduce the weight whole display screen, but also make it be easily partitioned in order to replace the parts of it and repair it.

### TECHNICAL FIELD OF THE INVENTION

The utility patent is related to field of display screen, especially a kind of LED matrix display screen.

### BACKGROUND OF THE INVENTION

LED matrix display screen is a way of display by controlling the light-emitting diodes of semiconductor. And it show character or pattern by turning on and turning off the lights. Currently the LED matrix display screens almost employ a block of circuit board with complex structure and wherein the spacing between lamps is wide. Consequently, the effect of display is not good and the display screen is heavy. Moreover, it cannot be repaired and the parts thereof cannot be replaced when damages occur.

### CONTENT OF INVENTION

Technical problems focused by the the utility patent is to provide a better and light LED matrix display which is easily installed, repaired and replaced.

A LED matrix display screen comprises multiple horizontal circuit board and vertical circuit board. Wherein the horizontal circuit board is equidistantly welded with LED lamps and wherein multiple horizontal circuit board are equidistantly welded on the vertical circuit board. Wherein the vertical circuit board, further comprising the controller, can respectively control the LED lamps on the horizontal circuit board.

Wherein the horizontal board is equidistantly equipped with five 3 W LED lamps(distance between the two LED lamps closed to each other among the five is 60 mm). And the vertical circuit board thereof is equidistantly welded with five horizontal circuit board.

Wherein the lower part of the vertical circuit board (3) is equipped with the radiating fin.

Embodiments of the utility patent have the following advantages:

The embodiment of the utility patent of the LED matrix display screen, can better display different graphics through equidistantly lined LED lamps. And each row of LED lamps are set in the horizontal circuit board. Result from that this utility patent shall not only reduce the spacing between the LED lamps, but also make the light emitted not be glare and too strong. Meanwhile, it shall reduce the weight of the entire display screen, and make it be easily partitioned in order to replace the parts thereof and repair it.

### DESCRIPTION OF THE DRAWINGS

FIG. 1 is a schematic diagram of the structure of the embodiment of the utility patent.

### SPECIFIC IMPLEMENTING METHODS

In order to make the purpose, technical proposal and advantages of this utility patent clearer, hereinafter it will be further described combined with the drawings.

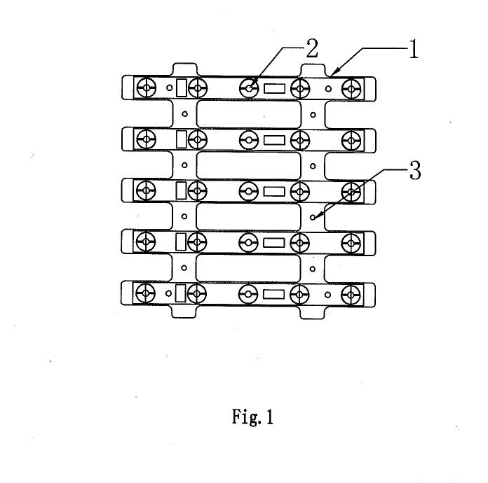

The embodiment of the utility patent of LED matrix display as shown in FIG. 1 comprises five horizontal circuit boards 1 which are welded with five 3 W LED lamps 2, and vertical circuit boards 3. And the five horizontal circuit boards are equidistantly welded on vertical circuit boards 3. Wherein the lower part of the horizontal circuit boards are equipped with radiating fins. Wherein horizontal circuit board 3 is equipped with a controller which can respectively control the LED lamps 2 on the horizontal circuit board 1. when LED lamps are energized, LED display screen will display graph according to that specified by the controller. For example where the outermost 16 LED lamps shine only it shall display a graph out. And it will display different shapes by light different LED lamps.

1. A LED matrix display screen comprises multiple horizontal circuit board (1) and vertical circuit board (3). Wherein the horizontal circuit board (1) is equidistantly welded with LED lamps (2) and wherein multiple horizontal circuit board (1) are equidistantly welded on the vertical circuit board (3). Wherein the vertical circuit board (3), further comprising the controller, can respectively control the LED lamps (2) on the horizontal circuit board (1).

2. The LED matrix display screen described in claim 1, wherein the horizontal board(1) is equidistantly equipped with five 3 W LED lamps (2) (distance between the two LED lamps closed to each other among the five is 60 mm). And the vertical circuit board (3) thereof is equidistantly welded with five horizontal circuit board (1).

3. The LED matrix display screen described in claim 1, wherein the lower part of the vertical circuit board (3) is equipped with the radiating fin.
